(19) United States
(12) Patent Application Publication
(10) Pub. No.: US 2004/0104585 A1
(43) Pub. Date: Jun. 3, 2004

(54) Snapable drive-in latch

(76) Inventors: Michael Winardi, Fullerton, CA (US); Jeanette Bui, Irvine, CA (US)

Correspondence Address: RICHARD J VELTMAN ESQ, BLACK & DECKER CORPORATION, 701 E JOPPA RD TW 199, TOWSON, MD, 21286, US

(21) Appl. No.: 10/307,618

(22) Filed: Dec. 2, 2002

(51) Int. Cl. E05B 9/00

(52) U.S. Cl. 292/337

(57) ABSTRACT

Certain exemplary embodiments of the present invention provide a removable drive-in housing assembly for securing a latch assembly in a door. The removable drive-in housing assembly can include a cylindrical casing having a longitudinal axis, said casing adapted to at least partially surround the latch assembly, and a seamless annular collar snapably attachable to said cylindrical casing. It is emphasized that this abstract is provided to comply with the rules requiring an abstract that will allow a searcher or other reader to quickly ascertain the subject matter of the technical disclosure. This abstract is submitted with the understanding that it will not be used to interpret or limit the scope or meaning of the claims.

### BRIEF DESCRIPTION OF THE DRAWINGS

The invention and its wide variety of potential embodiments will be readily understood via the following detailed description of certain exemplary embodiments, with reference to the accompanying drawings in which:

FIG. 1 is a perspective view of an exemplary embodiment of a system 100 of the present invention;

FIG. 2 is a perspective view of an exemplary embodiment of a system 100 of the present invention;

FIG. 3 is a front perspective view of an exemplary embodiment of a collar 40 of the present invention; and

FIG. 4 is a top view of an exemplary embodiment of a system 400 of the present invention.

### DETAILED DESCRIPTION

Certain exemplary embodiments of the present invention provide a removable drive-in housing assembly for securing a latch assembly in a door. The removable drive-in housing assembly can include a cylindrical casing having a longitudinal axis, said casing adapted to at least partially surround the latch assembly, and a unitary cylindrical collar snapably attachable to said cylindrical casing.

Certain exemplary embodiments of the present invention provide a removable drive-in housing assembly for securing a latch assembly in a door. The removable drive-in housing assembly can include a casing adapted to at least partially surround the latch assembly, and a seamless annular collar snapably attachable to said casing.

Certain exemplary embodiments of the present invention provide a removable drive-in housing assembly for securing a latch assembly in a door. The removable drive-in housing assembly can include a unitary collar receivable around an outer perimeter of a casing, the casing adapted to at least partially surround the latch assembly, said collar adapted to releasably engage with the door, and a means for snapably attaching the collar to the casing.

Certain exemplary embodiments of the present invention provide a system that can include a door grasp coupleable to a door, a latch assembly coupleable to said door grasp, a casing adapted to at least partially surround said latch assembly, and a unitary collar snapably attachable to said casing.

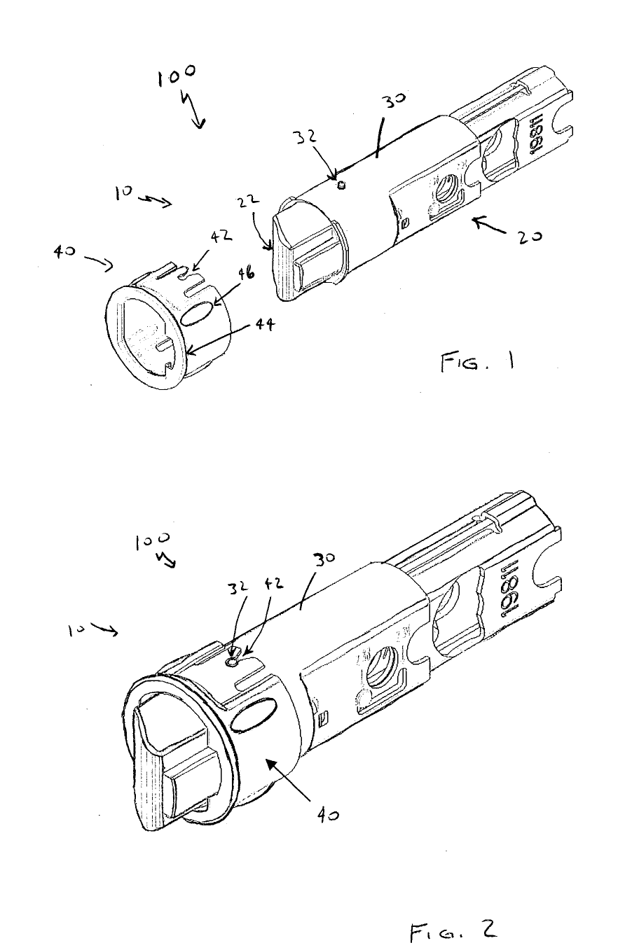

FIG. 1 is a perspective view of an exemplary embodiment of a system 100 of the present invention. System 100 can include a removable drive-in housing assembly 10 that, in an operative configuration, can be installed in a door (shown in FIG. 4), such as a residential door. Drive-in housing assembly 10 can include a latch assembly 20, that can be operable along a longitudinal axial dimension to engage and/or disengage a latch 22 with a latch plate (not shown) of a door frame (not shown). Latch 22 can be at least partially surrounded by a substantially cylindrical casing 30 having a longitudinal axis and having one or more radially outwardly extending protrusions 32 along its outer circumferential surface. Casing 30 can be fabricated from metal (e.g., drawn metal, steel, brass, etc.), polymer, and/or the like, such as an injection molded plastic (e.g., polyethylene, LDPE, HDPE, and/or nylon, etc.).

Removable drive-in housing assembly 10 can also include a collar 40, that can be seamless, continuous, substantially annular, substantially cylindrical, and/or unitary. In an operative configuration, collar 40 can be axially slid around casing 30, such that collar 40 surrounds a perimeter of casing 30. Further, protrusion 32 can be snapably received in clamping slot 42 of collar 40 to substantially attach collar 40 to casing 30, and/or to substantially limit and/or prevent rotational, radial, and/or axial movement of collar 40 with respect to casing 30. Thus, collar 40 can be axially, rotationally, and/or radially fixed with respect to casing 30.

Collar 40 can include a flange 44 that, in an operative configuration, can control a depth that collar 40 is received in the door. Collar 40 can include one or more outwardly extending ribs 46 that, in an operative configuration, can create an interference fit with the door. Collar 40 can be fabricated from metal (e.g., drawn metal, steel, brass, etc.), polymer, and/or the like, such as an injection molded plastic (e.g., polyethylene, LDPE, HDPE, and/or nylon, etc.).

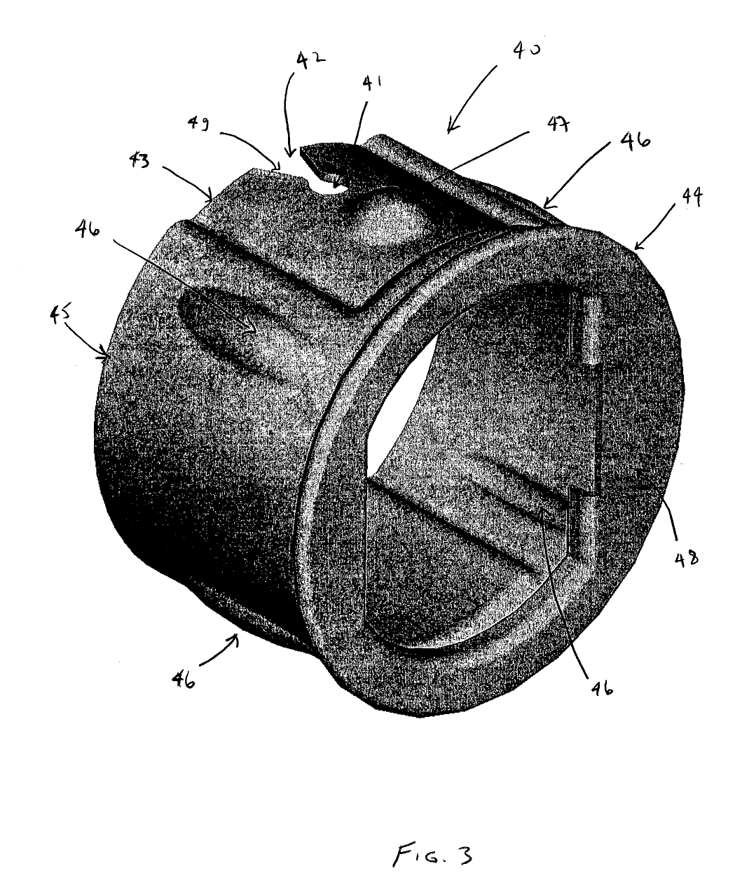

FIG. 2 is a perspective view of an exemplary embodiment of a system 100 and drive-in housing assembly 10 of the present invention, showing collar 40 surrounding casing 30, and showing protrusion 32 received within slot 42 to limit movement of casing 30 with respect to collar 40.

In certain embodiments, drive-in housing assembly 10 can accommodate non-destructive conversion from a snapped-on faceplate to a drive-in configuration, and vice versa. In certain embodiments, drive-in housing assembly 10 can securely hold latch assembly 20 within the door. In certain embodiments, drive-in housing assembly 10 can be easily manually installed into the door without special tools, and possibly without tools at all. In certain embodiments, drive-in housing assembly 10 can be manually, easily, and/or non-destructively removed from the door.

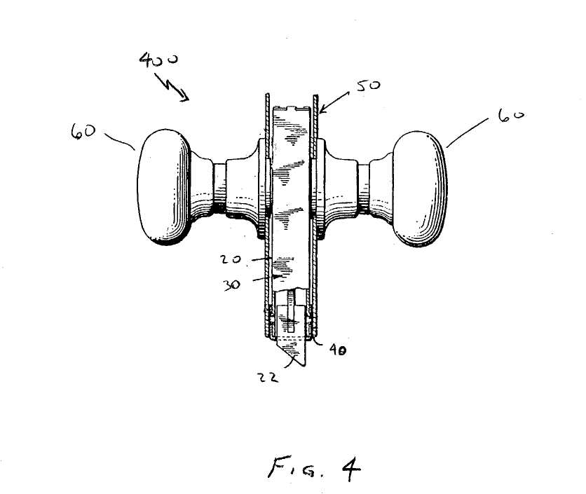

FIG. 3 is a front perspective view of an exemplary embodiment of a collar 40 of the present invention. Collar 40 can define one or more slots 42 for receiving a protrusion of the casing (shown in FIGS. 1 and 2). Slot 42 can include a V-shaped opening 49 that tapers to define a passage that is slightly narrower than an outside dimension of the protrusion. With application of a predetermined force, slot 42 and/or the protrusion can flex slightly to allow the protrusion to pass from V-shaped opening 49 into a C-shaped receiver 41 of slot 42 that can snugly contain the protrusion, and thereby causing a slight snap to be felt and/or heard. Slot 42 can be defined in a slot portion 43 of collar 40 that has a sufficiently smaller diameter than collar body 45 that the protrusion does not substantially interfere with and/or does not prevent insertion of drive-in housing assembly 10 into the door.

In various alternative embodiments (not shown), other means can be provided to snapably attach collar 40 to the casing. Such means can be at least partially integral to collar 40 and/or to the casing. For example, collar 40 can include at least one radially inwardly extending protrusion that can be snapably received in a slot of the casing to limit rotational, radial, and/or axial movement of collar 40 with respect to the casing. Such a slot can resemble a longitudinally and/or circumferentially extending groove and/or an indentation, and can be dimensioned to snugly receive the inwardly extending protrusion. The protrusion can extend sufficiently in an inward radial direction to cause an interference fit between collar 40 and the casing. The protrusion and/or the slot can have a slight degree of flex. Thus, as collar 40 is slid over the casing, once the protrusion fully encounters the slot, at least a slight snap can be heard and/or felt as the protrusion is received by the slot.

As another alternative example, similar to slot 42 of FIG. 3, the slot can resemble a longitudinally and/or circumferentially extending V-shaped opening coupled to a C-shaped receiver, and can be dimensioned to snugly receive the inwardly extending protrusion.

Collar 40 can include a flange 44 that can have a larger diameter than that of a body of collar 40. In an operative configuration, flange 44 can control a depth that collar 40 is received in a bore in the door. Attached to flange 44 can be a face plate 48 that can constrain radial movement of the latch and/or latch mechanism to correspond to radial movement of collar 40. As shown, collar 40 can include one or more ribs 46 extending axially along and outwardly from its outer circumferential surface. In an operative configuration, ribs 46 can create an interference fit with the door. Ribs 46 can be smoothed and/or rounded to ease insertion of drive-in housing assembly 10 into the door. Various releasable engagement means, such as protrusions 47, teeth, rings, etc., can be utilized in place or and/or to augment ribs 46.

FIG. 4 is a top cut-away view of an exemplary embodiment of a system 400 of the present invention. As shown, system 400 can include a door 50 coupled to a latch assembly 20 that is operable via one or more coupled door handles 60 and/or grasps (not shown). At least partially surrounding latch assembly 20 can be a latch casing 30, which can be at least partially surrounded by a collar 40 that can snugly interface with a bore defined in door 50. A latch 22 can interact with a latch plate (not shown) to secure the door in a closed position.

Although the invention has been described with reference to specific exemplary embodiments thereof, it will be understood that numerous variations, modifications and additional embodiments are possible, and accordingly, all such variations, modifications, and embodiments are to be regarded as being within the spirit and scope of the invention. Also, references specifically identified and discussed herein are incorporated by reference as if fully set forth herein. Accordingly, the drawings and descriptions are to be regarded as illustrative in nature, and not as restrictive.

What is claimed is:

1. A removable drive-in housing assembly for securing a latch assembly in a door, said removable drive-in housing assembly comprising:
a cylindrical casing having a longitudinal axis, said casing adapted to at least partially surround the latch assembly;
a seamless annular collar snapably attachable to said cylindrical casing.

2. A removable drive-in housing assembly according to claim 1, further comprising said latch assembly.

3. A removable drive-in housing assembly according to claim 1, further comprising said latch assembly, said latch assembly coupled to a door.

4. A removable drive-in housing assembly according to claim 1, further comprising said latch assembly, said latch assembly coupled to a door handle.

5. A removable drive-in housing assembly according to claim 1, said collar comprising at least one slot.

6. A removable drive-in housing assembly according to claim 1, said casing comprising at least one slot.

7. A removable drive-in housing assembly according to claim 1, said collar comprising at least one protrusion.

8. A removable drive-in housing assembly according to claim 1, said casing comprising at least one protrusion.

9. A removable drive-in housing assembly according to claim 1, wherein said collar is axially slidable over said cylindrical casing.

10. A removable drive-in housing assembly according to claim 1, wherein said collar is axially fixable to said cylindrical casing.

11. A removable drive-in housing assembly according to claim 1, wherein said collar is radially fixable to said cylindrical casing.

12. A removable drive-in housing assembly according to claim 1, wherein said collar is manually non-destructively removable from said cylindrical casing.

13. A removable drive-in housing assembly according to claim 1, said casing comprising at least one protrusion extending outward from an outer circumference of said cylindrical casing.

14. A removable drive-in housing assembly according to claim 1, said casing comprising at least one protrusion extending outward from an outer circumference of said cylindrical casing, said at least one protrusion snapably receivable in a longitudinally-extending slot of said collar.

15. A removable drive-in housing assembly according to claim 1, said casing comprising at least one protrusion extending outward from an outer circumference of said cylindrical casing, said at least one protrusion snapably receivable in a clamping slot of said collar.

16. A removable drive-in housing assembly according to claim 1, said casing comprising at least one protrusion extending outward from an outer circumference of said cylindrical casing, said at least one protrusion snapably receivable in a clamping slot of said collar, said slot having a “C”-shaped opening.

17. A removable drive-in housing assembly according to claim 1, said casing comprising at least one protrusion extending outward from an outer circumference of said cylindrical casing, said at least one protrusion snapably receivable in a longitudinally-extending slot of said collar, a reception of said at least one protrusion in said longitudinally-extending slot limiting movement of said casing with respect to said collar.

18. A removable drive-in housing assembly according to claim 1, said collar comprising at least one protrusion extending inward from an inner circumference of said collar, said at least one protrusion snapably receivable in a slot of said casing.

19. A removable drive-in housing assembly according to claim 1, said collar comprising at least one protrusion extending inward from an inner circumference of said collar, said at least one protrusion snapably receivable in a slot of said casing, a reception of said at least one protrusion in said slot limiting movement of said casing with respect to said collar.

20. A removable drive-in housing assembly according to claim 1, said collar comprising at least one releasable engagement means adapted to releasably engage with the door.

21. A removable drive-in housing assembly according to claim 1, wherein said collar is metallic.

22. A removable drive-in housing assembly according to claim 1, wherein, once installed in the door, at least a portion of said collar provides an interference fit with the door.

23. A removable drive-in housing assembly according to claim 1, wherein, once installed in the door, said collar is longitudinally fixed with respect to said casing.

24. A removable drive-in housing assembly for securing a latch assembly in a door, said removable drive-in housing assembly comprising:
a casing adapted to at least partially surround the latch assembly;
a unitary cylindrical collar snapably attachable to said casing.

25. A removable drive-in housing assembly for securing a latch assembly in a door, said removable drive-in housing assembly comprising:
a seamless collar receivable around an outer perimeter of a casing, the casing adapted to at least partially surround the latch assembly, said collar adapted to releasably engage with the door; and
means for snapably attaching the collar to the casing.

26. A removable drive-in housing assembly according to claim 25, said means limiting longitudinal movement of said collar with respect to the casing.

27. A removable drive-in housing assembly according to claim 25, said means limiting rotational movement of said collar with respect to the casing.

28. A removable drive-in housing assembly according to claim 25, at least a portion of said means integral to said collar.

29. A removable drive-in housing assembly according to claim 25, at least a portion of said means integral to said casing.

30. A system comprising:
a door grasp coupleable to a door;
a latch assembly coupleable to said door grasp;
a casing adapted to at least partially surround said latch assembly;
a seamless collar snapably attachable to said casing.
